(19) United States
(12) Patent Application Publication
(10) Pub. No.: US 2002/0077798 A1
(43) Pub. Date: Jun. 20, 2002

(54) Circuit simulation method and system

(75) Inventors: Seiichi Inoue, Tokyo (JP); Yoko Fujita, Tokyo (JP)

Correspondence Address: Paul J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 09/810,124

(22) Filed: Mar. 16, 2001

(30) Foreign Application Priority Data
Mar. 16, 2000 (JP) 2000-74793

(51) Int. Cl. G06F 17/50

(52) U.S. Cl. 703/19

(57) ABSTRACT

A circuit simulation method and system are provided, which can execute a highly precise delay analysis by generating a wiring structure which includes a target wiring conductor and a circumjacent wiring conductor in the circumferences of the target wiring conductor and which is generated in consideration of variation conditions, and by calculating a wiring capacitance on the basis of the wiring structure, thereby to highly precisely extracting a wiring capacitance in consideration of variation in fabricating process.

The circuit simulation system includes a layout information storing device 11, a wiring variation information storing device 12 for storing information of variations in wiring conductors, a process information storing device 13, a device 14 for extracting wiring resistance and wiring capacitance obtained in consideration of variation, by calculating wiring resistance and wiring capacitance obtained in consideration of variation, and by generating circuit connection information derived by modifying the circuit connection information in view of the wiring resistance and the wiring capacitance thus obtained, so that a delay simulation is executed in consideration of highly precise wiring capacitance.

### BACKGROUND OF THE INVENTION

The present invention relates to circuit simulation method and system, and more specifically to circuit simulation method and system for extracting a parasite capacitance and a parasite resistance from a layout pattern in a semiconductor integrated circuit in order to realize a highly precise simulation.

Recently, in semiconductor integrated circuits, a micro-fabrication in a fabrication process, a scale-up of a circuit scale and a high speed operation are rapidly advanced simultaneously. With the scale-up of the semiconductor integrated circuits, there increases the number of long wiring conductors attaining to a few ten millimeters, and on the other hand, a parasite capacitance per a unitary length and a parasite resistance per a unitary length increased with the micro-fabrication in the fabrication process. As a result, a delay caused by the wiring capacitance and the wiring resistance rapidly increases, and this becomes a main cause which determines the speed of a signal propagating on a wiring conductor.

On the other hand, with the speed-up of the semiconductor integrated circuit, it has become difficult to satisfactorily ensure a timing margin of the circuit, in particular, a timing margin of a critical path, in consideration of variation in fabrication process.

Therefore, it is extremely important to perform a delay simulation by precisely extracting the wiring resistance and the wiring capacitance at a layout design step and by causing a net list of the semiconductor integrated circuit to reflect the extracted parasite wiring resistance and the extracted parasite wiring capacitance.

One prior art of a circuit simulation method in consideration of variation in wiring resistance and in wiring capacitance occurring in a fabrication process is disclosed in Japanese Patent Application Pre-examination Publication No. JP-A-10-240796.

Now, the circuit simulation method disclosed in the above referred patent publication will be described with reference to FIG. 19.

First, in a step S192, a function describing net list which is a net list of a semiconductor integrated circuit constituted to include wiring resistance and wiring capacitance expressed in the form of a function, an electric characteristics of a device constituting a target circuit (device characteristics information) and a variation width in the device including parasite elements such as wiring resistance and wiring capacitance, are inputted.

In a next step S193, a central value, a maximum value and a minimum value of wiring resistance and wiring capacitance determined by the variation width of the wiring resistance and the wiring capacitance inputted in the step S192 are substituted into the function defined for the wiring resistance and the wiring capacitance, so that a wiring resistance value and a wiring capacitance value are calculated. Namely, in this step, the wiring resistance and the wiring capacitance are calculated as specific numerical values, in place of a function expression.

In a step S194, the wiring resistance and the wiring capacitance calculated in the step S193 are added into the net list, and a circuit simulation is carried out in accordance with the net list.

In a step S196, a variation condition is changed, and then, the processing in the steps S193 and S194 is carried out for all the conditions of the variation. Thus, the circuit simulation is carried out in consideration of variation in the fabrication process.

Next, a method for extracting the net list from the layout data in the above referred patent publication will be described with FIGS. 20 and 21.

FIG. 20 illustrates a layout pattern of a target wiring conductor 200 whose wiring resistance and wiring capacitance are to be extracted. This target wiring conductor 200 is cleaved into a wiring conductor segment between a node 210 and another node 220 by means of a suitable segmentalization.

It is assumed that the target wiring conductor 200 has a conductor width of 1 μm, a length of 10 μm between the node 210 and the node 220, and a resistance of R10 between the node 210 and the node 220.

FIG. 21A shows a circuitry prepared by extracting the wiring resistance and the wiring capacitance from the target wiring conductor 200 shown in FIG. 20, and by approximating the target wiring conductor 200 to a L-type lumped-parameter circuit. Here, C20 indicates a bottom capacitance between a bottom of the target wiring conductor 200 and a substrate, and C21 and C22 denote a fringe capacitance between each side of the target wiring conductor 200 and the substrate. FIG. 21B diagrammatically illustrates a relation between the capacitance C20, C21 and C22 and the target wiring conductor 200.

Now, the description of the wiring resistance and the wiring capacitance on the net list disclosed in the above referred patent publication will be explained with FIG. 22 which shows, in the form of a net list, the equivalent circuit of the target wiring conductor 200 shown in FIG. 21B.

A first line in FIG. 22 indicates that the resistance value RAL per unitary length is 0.1Ω, and second and third lines show that the bottom capacitance CBAL per unitary length and the fringe capacitance CFAL per unitary length are 0.01 fF and 0.005 fF, respectively.

Furthermore, a fourth line expresses that the resistance R10 between the nodes 210 and 220 shown in FIGS. 20 and 21 is calculated by R10=10×RAL. Here, the first “10” indicates the length of the resistor R10 shown in FIG. 20, and “RAL” indicates 0.1Ω which is the value of the parameter defined on the first line in FIG. 22.

A fifth line represents that the bottom capacitance C20 between the node 220 and the ground node 0 shown in FIG. 21 is calculated by C20=10×CBAL. Here, the first “10” indicates that the bottom area of the bottom capacitance C20 is 10 μm×1 μm=10 m², as seen from FIG. 20. Accordingly, it indicates that the bottom capacitance C20 is calculated by multiplying the bottom area by the bottom capacitance CBAL per unitary area, defined on the second line in FIG. 22.

As mentioned above, the wiring resistance and the wiring capacitance in consideration of variation in the fabrication process, is calculated by expressing the wiring resistance and the wiring capacitance in the form of a function and by changing the value to be substituted into the functions, in accordance with the variation in the fabrication process.

The circuit simulation method disclosed in the above referred JP-A-10-240796 can precisely calculate the wiring resistance and the wiring capacitance in consideration of variation conditions, in the case of a simple wiring construction, for example, in the case that a wiring conductor exists isolatedly as shown in FIG. 20, and in the case that the other wiring conductor or conductors exist in parallel to and adjacent to the wiring conductor 200.

Actually, however, in a layout pattern generated by an automatic layout machine, wiring conductors exist around the target wiring conductor whose wiring resistance and wiring capacitance are to be calculated, namely, many peripheral wiring conductors exist, at complicated positions in relation to the target wiring conductor, to extend in a horizontal direction and in a vertical direction, with the result that the wiring capacitance of the target wiring conductor greatly changes under influence of the peripheral wiring conductors.

Therefore, in order to highly precisely obtain the wiring capacitance, it is necessary to construct the function not only in consideration of the target wiring conductor whose wiring capacitance is to be calculated, but also in consideration of a wiring structure including the target wiring conductor and peripheral wiring conductors existing around the target wiring conductor as well as variation in distance between the target wiring conductor and the peripheral wiring conductors. For all variation conditions, it is difficult to precisely calculate the wiring capacitance of the target wiring conductor by defining the wiring resistance and the wiring capacitance in the form of a function.

### BRIEF SUMMARY OF THE INVENTION

Accordingly, it is a first object of the present invention to provide circuit simulation method and system capable of highly precisely extracting the wiring capacitance of a target wiring conductor in consideration of variation in a fabrication process, by generating a wiring structure including a target wiring conductor as well as a side wiring conductor and a crossing wiring conductor existing around the target wiring conductor, in consideration of variation of those wiring conductors, and by calculating the wiring capacitance on the basis of the wiring structure thus obtained, without obtaining variation in a target wiring conductor capacitance in consideration of the target wiring conductor as well as the side wiring conductor and the crossing wiring conductor existing around the target wiring conductor, by simply changing the arguments in the function.

A second object of the present invention is to provide circuit simulation method and system requiring only a small data amount by one net list of a semiconductor integrated circuit including information of a wiring resistance and a wiring capacitance in consideration of all variation conditions, without individually generating net lists corresponding to all the variation conditions, respectively.

A third object of the present invention is to provide circuit simulation method and system capable of reducing a load for a designer who generates the wiring, with a less generation of mistake, by automatically generating a target wiring conductor and a side wiring conductor as well as a crossing wiring conductor in consideration of variation with reference to wiring variation information, without causing the designer to manually generate the wiring structure in consideration of variation conditions.

A fourth object of the present invention is to provide circuit simulation method and system capable of rapidly calculating the wiring resistance and the wiring capacitance by generating, on the basis of variation conditions, only a wiring structure composed of the target wiring conductor and peripheral wiring conductors influencing the capacitance of the target wiring conductor, and then by calculating the wiring resistance and the wiring capacitance, differently from a method for calculating the wiring resistance and the wiring capacitance of the target wiring conductor by generating wiring structure of all wiring conductors formed on a semiconductor chip, in the number of the kinds of variation condition; and by inputting layout data corresponding to all the variation conditions.

A circuit simulation method in accordance with the present invention comprises:

a wiring conductor retrieving step of retrieving, on the basis of a layout information of an integrated circuit, a designated target wiring conductor included in the layout information, a side wiring conductor adjacent to the target wiring conductor and positioned at the same wiring conductor level as that of the target wiring conductor, and a crossing wiring conductor spatially crossing the target wiring conductor;

a variational wiring conductor generating step of generating variational target wiring conductors, variational side wiring conductors and variational crossing wiring conductors in consideration of variation in the target wiring conductor, the side wiring conductor and the crossing wiring conductor, on the basis of connection information of the target wiring conductor, the side wiring conductor and the crossing wiring conductor and a wiring conductor variation information which is variation information of wiring conductors, so as to generate variational wiring structures constituted of the variational target wiring conductors, the variational side wiring conductors and the variational crossing wiring conductors;

a wiring conductor segmentalizing step of segmentalizing the variational target wiring conductor into wiring segments on the basis of a wiring structure constituted of wiring conductors including the target wiring conductor, the side wiring conductor and the crossing wiring conductor;

a wiring resistance calculating step of calculating a wiring resistance of the wiring segments on the basis of process information and information of the wiring segments;

a wiring capacitance calculating step of calculating a wiring capacitance of the wiring segments included in the variational wiring structures, for each of variation conditions, by referring to information of a wiring structure model which is a fundamental wiring structure constituted of wiring conductors including the target wiring conductor, the side wiring conductor and the crossing wiring conductor, to capacitance model information including information of wiring capacitance of the target wiring conductor included in the wiring structure model, calculated on the basis of information of the wiring structure model and the process information, and to the variational wiring structures;

a circuit connection information generating step for generating circuit connection information including information of the wiring resistance and the wiring capacitance, on the basis of the wiring resistance and the wiring capacitance calculated in the wiring resistance calculating step and the wiring capacitance calculating step, respectively; and

a variation considering delay analysis step of executing a delay analysis of the integrated circuit in consideration of variation in the wiring resistance and the wiring capacitance included in the circuit connection information, on the basis of the circuit connection information including information of the wiring resistance and the wiring capacitance, generated in the circuit connection information generating step.

A circuit simulation system in accordance with the present invention comprises:

a layout information storing means for storing layout information of an integrated circuit;

a wiring variation information storing means for storing information of variations in wiring conductors;

a process information storing means for storing process information in a fabricating process for the integrated circuit;

a means for extracting wiring resistance and wiring capacitance obtained in consideration of variation, by extracting wiring resistance and wiring capacitance obtained in consideration of variation, on the basis of the layout information, the wiring variation information and the process information, so as to generate circuit connection information including information of wiring resistance and wiring capacitance derived by modifying the circuit connection information of the integrated circuit in view of the wiring resistance and the wiring capacitance thus obtained, and

a simulation means receiving the circuit connection information including the wiring resistance and the wiring capacitance, for executing a delay simulation of the integrated circuit in consideration of variation in the wiring conductors.

### BRIEF DESCRIPTION OF THE DRAWINGS

FIG. 1 is a block diagram illustrating an embodiment of the circuit simulation system in accordance with the present invention;

FIG. 2 is one example of variation information of wiring conductors, stored in a wiring conductor variation storing means in FIG. 1;

FIG. 3 is a flow chart illustrating an operation of the means shown in FIG. 1 for extracting wiring resistance and wiring capacitance obtained in consideration of variation;

FIG. 4 is a flow chart illustrating an operation of the variation considering simulation means shown in FIG. 1;

FIG. 5 is a flow chart illustrating a method for extracting a side wiring conductor, in the circuit simulation method and system in accordance with the present invention;

FIG. 6 is a flow chart illustrating a method for segmentalizing a target wiring conductor, in the circuit simulation method and system in accordance with the present invention;

FIG. 7 is a wiring conductor layout pattern illustrating a method for segmentalizing a target wiring conductor, in the circuit simulation method and system in accordance with the present invention;

FIGS. 8A, 8B and 8C are wiring conductor layout patterns for illustrating the step S12 in FIG. 3;

FIGS. 9A, 9B and 9C are diagrams for illustrating a wiring resistance calculating method, in the circuit simulation method and system in accordance with the present invention;

FIGS. 10A, 10B and 10C are examples of a wiring structure model which gives capacitance mode information stored in the capacitance model information storing means in FIG. 3;

FIG. 11 is a flow chart illustrating the wiring resistance calculating method in the step S15 in FIG. 3;

FIGS. 12A and 12B diagrams for illustrating the processing content in the steps S114 and S115 in FIG. 11;

FIG. 13 is a layout pattern in the case that a crossing point between a target wiring conductor and a crossing wiring conductor is set, in the wiring structures shown in FIGS. 8A, 8B and 8C;

FIG. 14 is a “π”-type approximated equivalent circuit diagram including a wiring resistance and a wiring capacitance between nodes shown in FIG. 13;

FIGS. 15A and 15B are example of circuit connection information including the wiring resistance and the wiring capacitance obtained in consideration of variation between nodes shown in FIG. 14;

FIG. 16A is an example of circuit connection information including the wiring resistance and the wiring capacitance, inputted in the step S41 in FIG. 4;

FIG. 16B is a circuit connection information for delay analysis, corresponding to the circuit connection information shown in FIG. 16A;

FIGS. 17A and 17B are the circuit connection information for delay analysis shown in FIG. 16B and its equivalent circuit diagram, shown by using conductance;

FIG. 18 is a circuit matrix for delay analysis, prepared on the basis of the circuit diagrams shown in FIGS. 17A and 17B;

FIG. 19 is a flow chart illustrating the prior art circuit simulation method;

FIG. 20 is a layout pattern illustrating the method for extracting a wiring resistance and a wiring capacitance, in the prior art circuit simulation method;

FIGS. 21A and 21B are equivalent circuit diagrams derived from the layout pattern of FIG. 20, for illustrating the method for extracting a wiring resistance and a wiring capacitance, in the prior art circuit simulation method; and

FIG. 22 is a net list of the equivalent circuit diagram of the target wiring conductor shown in FIG. 21A.

### DETAILED DESCRIPTION OF THE INVENTION

Now, embodiments of the present invention will be described with reference to the drawings.

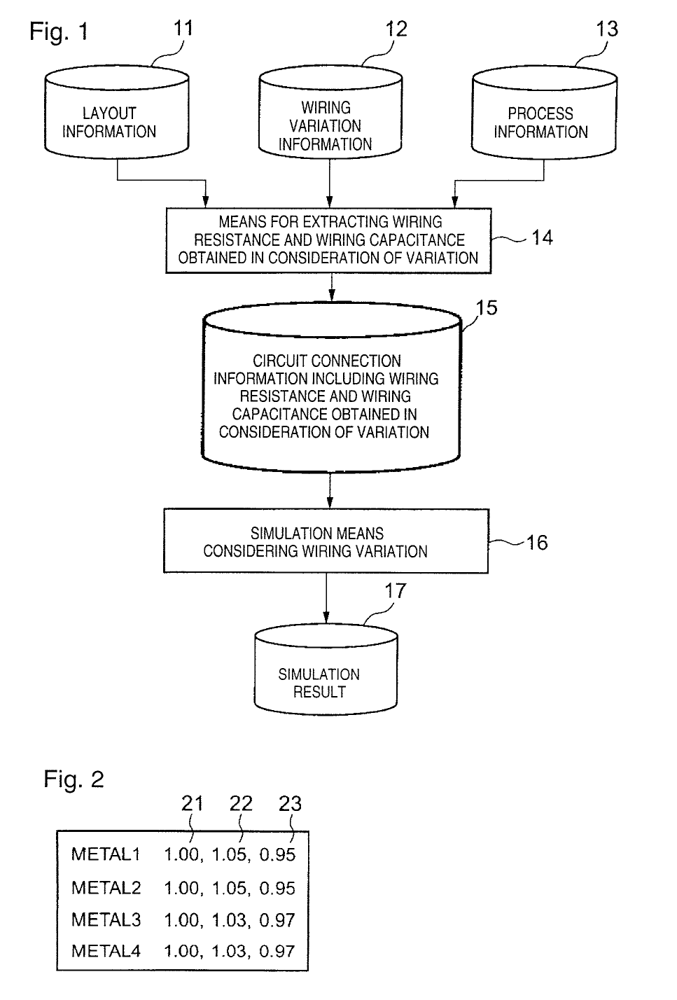

FIG. 1 is a block diagram illustrating an embodiment of the circuit simulation system in accordance with the present invention. The circuit simulation system in accordance with the present invention includes a layout information storing means 11 for storing layout information which includes layout information of circuit blocks including basic cells, macro cells having a relatively large circuit scale and/or input/output buffers, and wiring information for interconnecting between circuit blocks, a wiring variation information storing means 12 for storing information of variations in processes for forming wiring conductors between circuit blocks, and a process information storing means 13 for storing process information including wiring sheet resistance indicative of resistivity per a unit length of each of various wiring layers, and a central value and a variation width of a film thickness and a dielectric constant of an insulating layer formed between various wiring layers.

The circuit simulation system in accordance with the present invention further includes a means 14 for extracting wiring resistance and wiring capacitance obtained in consideration of variation, this means calculating wiring resistance and wiring capacitance obtained in consideration of variation, on the basis of the layout information, the wiring variation information and the process information, and generating circuit connection information including information of wiring resistance and wiring capacitance derived by modifying the circuit connection information in view of the wiring resistance and the wiring capacitance thus obtained, and a circuit connection information storing means 15 for storing circuit connection information which includes the wiring resistance and the wiring capacitance generated by the wiring resistance and wiring capacitance extracting means 14.

Here, a target circuit may be the whole of an integrated circuit, or alternatively, a circuit block constituting a portion of the integrated circuit, or a macro cell such as an accumulated addition circuit and a digital filter.

Moreover, the circuit simulation system in accordance with the present invention further includes a simulation means 16 receiving the circuit connection information including the wiring resistance and the wiring capacitance, from the circuit connection information storing means 15, for executing a delay simulation of a circuit in consideration of a wiring variation, and a simulation result storing means 17 for storing a simulation result including a dump list and a timing chart generated by the simulation means 16 taking the wiring variation into consideration.

Now, the wiring variation information will be described with reference to FIG. 2.

In FIG. 2, “METAL1” to “METAL4” indicate wiring conductor layer numbers. For example, “METAL1” indicates a first level wiring layer. Here, the wiring layer is conventionally formed of aluminum, but may be formed of a different metal such as gold or an impurity-doped polysilicon.

“21” to “23” indicate variation information of the wiring conductor width of “METAL1” to “METAL4”. Specifically, the wiring conductor width variation condition 21 indicates that the variation of the wiring conductor width of “METAL1” to “METAL4” is 0 (zero). In other words, it means that a central value of the wiring conductor width of “METAL1” to “METAL4” is a standardized “1.00”. The wiring conductor width variation condition 22 indicates a maximum wiring conductor width when the central value of the wiring conductor width of “METAL1” to “METAL4” is standardized to “1.00”. The wiring conductor width variation condition 23 indicates a minimum wiring conductor width when the central value of the wiring conductor width of “METAL1” to “METAL4” is standardized to “1.00”.

In addition, the wiring resistance and the wiring capacitance has correlation to the wiring conductor width. If the wiring conductor width becomes large, the wiring resistance becomes small, but the wiring capacitance becomes large. Under the wiring conductor width variation condition 22 where the wiring conductor width becomes maximum, the wiring resistance is minimum and the wiring capacitance is maximum. Under the wiring conductor width variation condition 23 where the wiring conductor width becomes minimum, the wiring resistance is maximum and the wiring capacitance is minimum.

In the above mentioned example, a variation width have the same amount to the central value in a positive direction and in a negative direction, but may be in asymmetry.

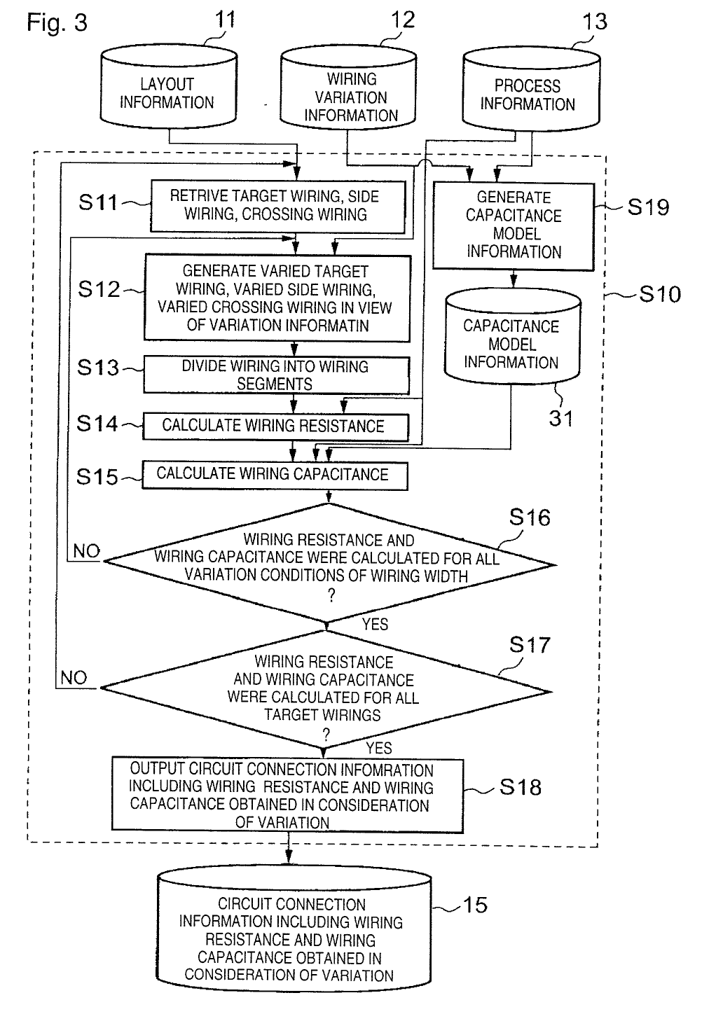

Next, with reference to a processing flow shown in FIG. 3, an operation of the means 14 shown in FIG. 1 for extracting wiring resistance and wiring capacitance obtained in consideration of variation, will be described. A step S10 is a processing flow for illustrating the operation of the means 14 for extracting wiring resistance and wiring capacitance obtained in consideration of variation, and includes steps S11 to S19.

In the first step S11, a target wiring conductor of a target circuit, a side wiring conductor which is located at the same wiring layer as that of the target wiring conductor and is positioned within a predetermined distance from the target wiring conductor, and a crossing wiring conductor which is located at a wiring layer different from that of the target wiring conductor and extends to cross the target wiring conductor, are retrieved from the layout information 11.

The wiring capacitance of the target wiring conductor is greatly dependent upon wiriness which exist in the neighborhood of the target wiring conductor, and therefore, in order to highly precisely calculate the wiring capacitance, it is necessary to retrieve not only the target wiring conductor but also the side wiring conductor and/or the crossing wiring conductor which exist in the neighborhood of the target wiring conductor.

Here, the target circuit is either the whole of an integrated circuit or a portion of the integrated circuit or the macro cell. The target wiring conductor is either all wiring conductors included in the target circuit, or a portion of all wiring conductors, such as critical path. What is selected and which of wiring conductors is selected as the target wiring, are designated by a designer.

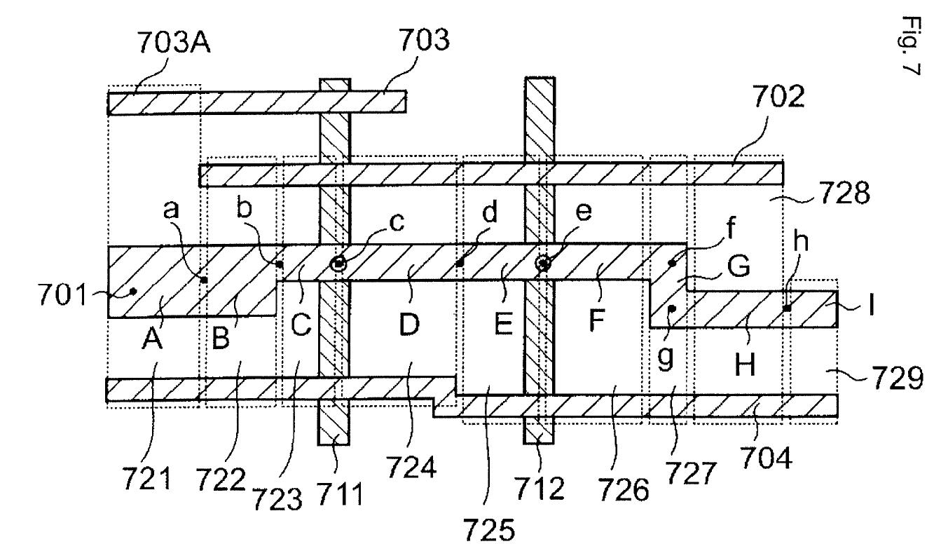

Referring to FIG. 7, the reference number 701 designates the target wiring conductor, a wiring conductor 703A within a segmentary area 701 of a wiring conductor 703 and wiring conductors 702 and 707 are a side wiring conductor. The reference numbers 711 and 712 indicate a crossing wiring conductor.

In a step S12, a variational target wiring conductor, a variational side wiring conductor and a variational crossing wiring conductor, in consideration of variation information, are generated by using the information of the target wiring conductor, the side wiring conductor and the crossing wiring conductor retrieved in the step S11, as well as wiring variation information stored in the wiring variation information storing means 12.

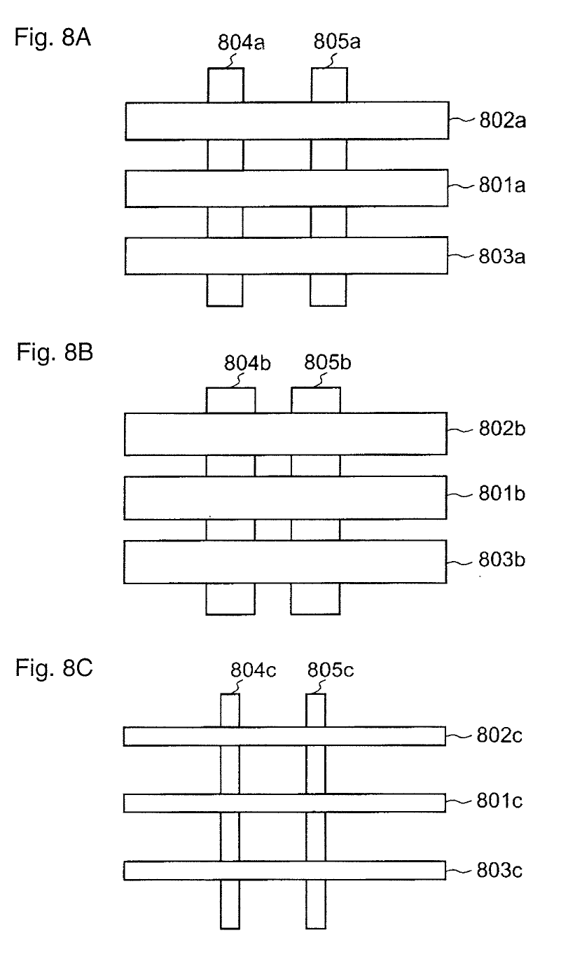

A processing of the step S12 will be described in detail with reference to FIGS. 8A, 8B and 8C.

FIG. 8A shows a wiring structure simplified for simplifying the wiring structure shown in FIG. 7. The reference number 801a designates the target wiring conductor formed of “METAL2” in FIG. 2. The reference numbers 802a and 803a indicate side wiring conductors which are formed of the same wiring conductor layer as that of the target wiring conductor 801a and which are located in parallel to the target wiring conductor 801a. The reference numbers 804a and 805a show crossing wiring conductors which are formed of “METAL2” in FIG. 2 at a level lower than that of the target wiring conductor 801a and extend to cross the target wiring conductor 801a.

Furthermore, FIG. 8A illustrates the wiring structure corresponding to the wiring conductor width variation condition 21 in FIG. 2, namely, the wiring structure based on the variation of 0 (zero), or the central value in the fabricating process.

FIG. 8B illustrates the wiring structure corresponding to the wiring conductor width variation condition 22 in FIG. 2, namely, the wiring structure in which both of “METAL1” and “METAL2” have a wiring conductor width larger than that of the wiring conductors shown in FIG. 8A, by 5%. FIG. 8C illustrates the wiring structure corresponding to the wiring conductor width variation condition 23 in FIG. 2, namely, the wiring structure in which both of “METAL1” and “METAL2” have a wiring conductor width smaller than that of the wiring conductors shown in FIG. 8A, by 5%.

As mentioned above, by using information of the target wiring conductor 801a, the side wiring conductors 802a and 803a and the crossing wiring conductors 804a and 805a as well as the wiring variation information 21 to 23, the step S12 automatically generates variational target wiring conductors 801b and 801c, variational side wiring conductors 802b, 803b, 802c and 803c and variational crossing wiring conductors 804b, 805b, 804c and 805c.

Accordingly, in the circuit simulation method and system in accordance with the present invention, the wiring structure is not generated by a designer manually taking a variation condition into consideration, but the variational target wiring conductors, the variational side wiring conductors and the variational crossing wiring conductors are automatically generated, so that a designer's load is small and no mistake occurs.

Furthermore, differently from a method in which the wiring structures of all wiring conductors formed on a semiconductor chip are generated in the number of variation conditions and the wiring resistance and the wiring capacitance of the target wiring conductor are calculated on the basis of layout data corresponding to all the variation conditions, the circuit simulation method and system in accordance with the present invention can calculate the wiring resistance and the wiring capacitance at a high speed since only the wiring structure, based on the variation conditions, composed of the target wiring conductor and the circumjacent wiring conductors giving influence to the capacitance of the target wiring conductor, is generated and then the wiring resistance and the wiring capacitance are calculated.

Next, in a step S13, the target wiring conductor and the side wiring conductors are divided into wiring conductor segments, by paying attention to changing points of the target wiring conductor, the side wiring conductors and the crossing wiring conductors, such as a wiring spacing changing point where a spacing between the target wiring conductor and the side wiring conductor changes, and a wiring conductor width changing point where the conductor width of the target wiring conductor changes.

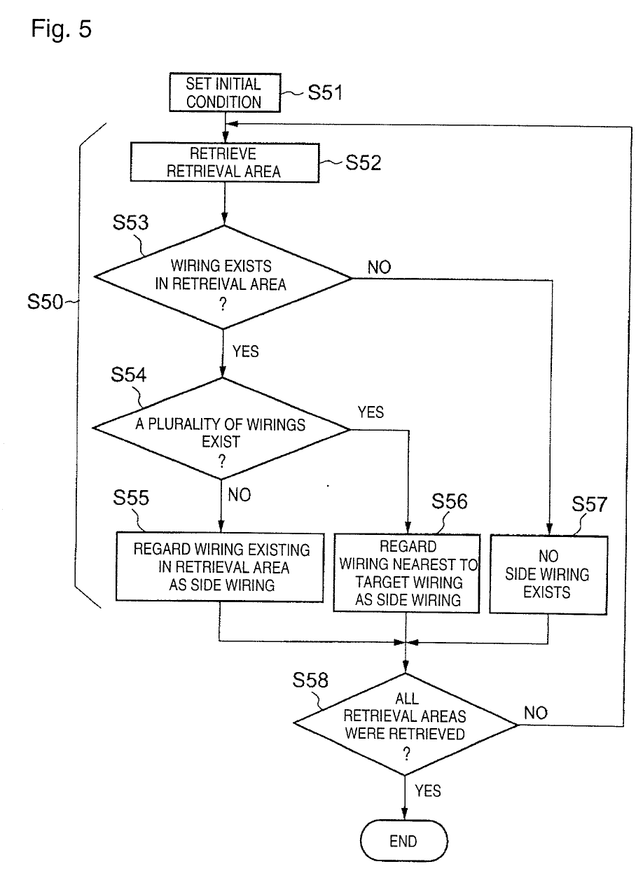

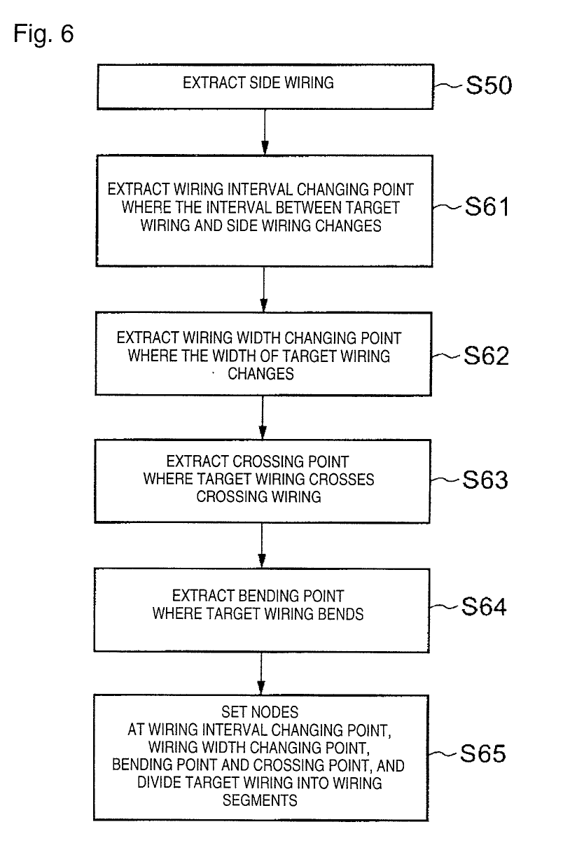

A method for extracting the side wiring conductor will be described with reference to FIG. 5, and thereafter, the method for dividing the target wiring conductor will be described with reference to FIGS. 6 and 7. FIG. 5 is a processing flow chart of the step S50 illustrating the method for extracting the side wiring conductor, and includes processing of steps S51 to S58.

In an initial conduction setting of the step S51, a retrieval area width indicative of a retrieving distance from the target wiring conductor in retrieving the side wiring conductors is set, as a wiring conductor existing within five grids from the target wiring conductor is regarded to be the side wiring conductor but a wiring conductor separated from the target wiring conductor by six or more grids is not regarded to be the side wiring conductor.

In a next step S52, a plurality of retrieval areas set in a wiring length direction of the target wiring conductor are sequentially retrieved, and one retrieval area is selected.

In a succeeding step S53, whether or not a wiring conductor exists in the retrieval area selected in the step S52, is discriminated. If no wiring conductor exists, it is decided in a step S57 that no side wiring conductor exists. When it is discriminated that a wiring conductor exists in the retrieval area, whether or not a plurality of wiring conductors exist in the retrieval area is discriminated in a step S54.

If it is discriminated in the step S54 that a plurality of wiring conductors do not exist in the retrieval area, it is decided in a step S55 that an existing wiring conductor is a side wiring conductor. When it is discriminated that a plurality of wiring conductors exist in the retrieval area, it is decided that the nearest wiring conductor nearest to the target wiring conductor, of the plurality of wiring conductors, is a side wiring conductor.

Then, in a step S58, whether or not all of the retrieval areas have been retrieved, is discriminated. When all of the retrieval areas have been retrieved, the processing for extracting the side wiring conductor is completed. If all of the retrieval areas have not yet been retrieved, namely, if a not-retrieved retrieval area remains, the operation returns to the step S52, the processing of the steps S52 to S57 is repeated until the retrieval areas have been retrieved.

Now, a method for segmentalizing the target wiring conductor and the side wiring conductor will be described with reference to FIG. 6.

In FIG. 6, after the side wiring conductor is extracted in the step S50 as mentioned above, a wiring spacing changing point where a spacing between the target wiring conductor and the side wiring conductor changes, is extracted in a step S61.

In FIG. 7, a point where the wiring conductor nearest to the target wiring conductor changes from the side wiring conductor 703A to the side wiring conductor 702 is a wiring spacing changing point “a”, and segmentary area 721 including the wiring conductor 703A and a side which passes through the wiring spacing changing point “a” and which is perpendicular to the target wiring conductor 701, is circumscribed.

Furthermore, a point “d” where the wiring conductor nearest to the target wiring conductor 701 changes because the side wiring conductor 704 is bent, and a point “h” where the side wiring conductor 702 disappears, constitute a wiring spacing changing point. Based on these wiring spacing changing points “d” and “h”, segmentary areas 724, 725, 728 and 729 are circumscribed.

In a next step S62, a wiring conductor width changing point where the conductor width of the target wiring conductor changes, is extracted. In FIG. 7, a point “b” where the conductor width of the target wiring conductor 701 changes is the wiring conductor width changing point. A segmentary area 722 is circumscribed on the basis of this point and the wiring spacing changing point “a”.

In a succeeding step S63, a crossing point where the target wiring conductor crosses a crossing wiring conductor, is extracted. In FIG. 7, points “c” and “e” where the crossing wiring conductors 711 and 712 crosses the target wiring conductor 701, respectively, constitute the crossing point. On the basis of these crossing points “c” and “e”, segmentary areas 723 and 724 and segmentary areas 725 and 726 are circumscribed.

In a next step S64, a bending point where the target wiring conductor bends, is extracted. In FIG. 7, the bending point is points “f” and “g” where the target wiring conductor 701 bends. On the basis of these bending points “f” and “g”, segmentary areas 726, 727 and 728 are circumscribed.

Succeedingly, in a step S65, nodes are set on the wiring spacing changing points, the wiring conductor width changing points, the crossing points and the bending points extracted in the steps S61 to S64, and node numbers are given to the nodes thus set. On the basis of the nodes thus set, the target wiring conductor is segmentalized into wiring conductor segments, namely, wiring conductor segments “A” to “I” each circumscribed between a pair of adjacent nodes.

The order of the steps S61 to S64 is not necessarily in accordance with that shown in FIG. 6, but may be arbitrary. For example, the order of the steps S61 to S64 can be inverted, as the step S64 to the step S63 to the step S62 to the step S61.

In addition, in connection with the example in shown in FIG. 3, it has been explained that after the processing of the step S12 is carried out, the processing of the step S13 is carried out. However, after the processing of the step S13, namely, the segmentalization of the target wiring conductor, is carried out, the variational wiring conductors in the step S12 can be generated, and then, the processing of the step S14 and the succeeding steps can be carried out.

Returning to FIG. 3, for the wiring conductor segments extracted in the step S13, the wiring resistance of the target wiring conductor in consideration of variation is calculated in the step S14 by considering the variation information of the sheet resistance stored in the process information storing means 13.

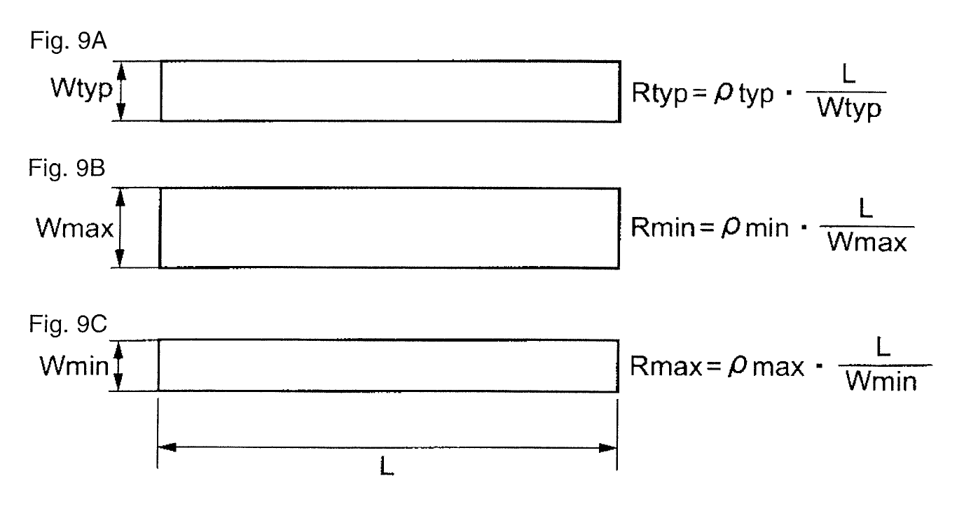

Now, a calculating method of a wiring resistance R will be described with reference to FIGS. 9A, 9B and 9C. FIG. 9A corresponds to the case of FIG. 8A, and illustrates the case of the variation of 0 (zero), namely, the wiring conductor width having the central value in the fabrication variation. Under this case, assuming that the wiring conductor width is Wtyp, the wiring length is L, and the sheet resistance is ρtyp, the wiring resistance Rtyp is calculated as Rtyp=ρtyp×(L/Wtyp).

FIG. 9B corresponds to the case of FIG. 8B, and illustrates the case that the wiring conductor width is maximum in the fabrication process. Under this case, assuming that the wiring conductor width is Wmax and the sheet resistance is pmin, the wiring resistance Rmin is calculated as Rmin=ρmin×(L/Wmax).

Incidentally, the above calculation is based on the worst case by putting the sheet resistance as the minimum value ρmin. In a calculation focusing on the variation of the wiring conductor width, ρtyp may be used in place of ρmin.

FIG. 9C corresponds to the case of FIG. 8C, and illustrates the case that the wiring conductor width is minimum in the fabrication process. Under this case, assuming that the wiring conductor width is Wmin and the sheet resistance is ρmax, the wiring resistance Rmax is calculated as Rmax=ρmax×(L/Wmin). This wiring resistance Rmax is based on the worst case.

In this step as mentioned above, the wiring resistance is calculated in accordance with the wiring conductor variation conditions supplied from the wiring variation information storing means 12 in the step S12.

In the step S15, the wiring capacitance is calculated on the basis of the information of the variational target wiring conductors, the variational side wiring conductors and the variational crossing wiring conductors generated in the step S12 as well as capacitance mode information stored in a capacitance mode information storing means 31. Before the content of the processing of the step S15 is explained, a capacitance mode information generation carried out in a step S19 and capacitance mode information generated as the result of this processing will be described.

In the step S19, on the basis of the process information including the film thickness of the wiring conductor layer, the film thickness of an interlayer insulating film between wiring conductor layers, the dielectric constant of the interlayer insulating film, and also on the basis of the wiring conductor variation information, the capacitance mode information is generated by means of a capacitance simulator, and is outputted to the capacitance mode information storing means 31.

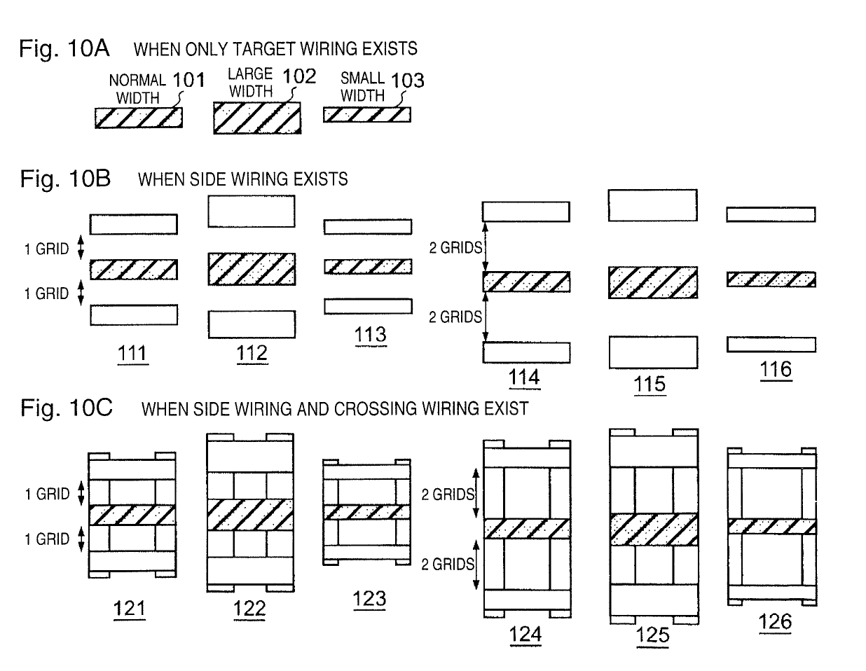

Now, the capacitance mode information will be specifically described with reference to FIGS. 10A, 10B and 10C.

FIGS. 10A, 10B and 10C are examples of a wiring structure model which gives capacitance mode information stored in the capacitance model information storing means 31 in FIG. 3. FIG. 10A illustrates an isolated target wiring conductor, and the reference number 101 shows a wiring structure model having the wiring conductor width of the variation central value. The reference number 102 shows a wiring structure model having the wiring conductor width of the variation maximum value, and the reference number 103 shows a wiring structure model having the wiring conductor width of the variation minimum value. Accordingly, the model 101 corresponds to the case of FIG. 8A, the model 102 corresponds to the case of FIG. 8B, and the model 103 corresponds to the case of FIG. 8C.

FIG. 10B illustrates the case that the side wiring conductor exists. The reference numbers 111 to 113 shows wiring structure models in which the spacing between the hatched target wiring conductor and the side wiring conductor is one grid, and the reference numbers 114 to 116 shows wiring structure models in which the spacing between the hatched target wiring conductor and the side wiring conductor is two grids.

FIG. 10C illustrates the case that there exist not only the side wiring conductor but also the crossing wiring conductor. The reference numbers 121 to 123 shows wiring structure models in which the spacing between the hatched target wiring conductor and the side wiring conductor is one grid, and the reference numbers 124 to 126 shows wiring structure models in which the spacing between the hatched target wiring conductor and the side wiring conductor is two grids.

Here, the wiring lengths of both the target wiring conductor and the side wiring conductor are unitary lengths.

The wiring structure models shown in FIGS. 10A, 10B and 10C are a portion of wiring structure models generated in the step S19, and wiring structure models are previously prepared which include models until models in which the side wiring conductor is apart from the target wiring conductor until a distance which no longer influences the capacitance of the target wiring conductor. The separation distance (grid unit) is designated for each process.

The case shown in FIG. 10C has the wiring structure in which opposite ends of the target wiring conductor are determined by the crossing points. Other wiring structure models having the wiring spacing changing points, the wiring conductor width changing points and the bending points in place of the crossing points, are prepared.

Incidentally, FIGS. 10B and 10C show examples in which the side wiring conductor is located at each side of the target wiring conductor. Those models may be modified to models in which the side wiring conductor is located at only one side of the target wiring conductor. Furthermore, in connection with the wiring conductor width, the wiring conductor models shown in FIGS. 10A, 10B and 10C may be constructed by using a plurality of wiring conductor widths which are frequently used in semiconductor integrated circuits. As such, by preparing many wiring structure models meeting with an actual layout wiring structure, even if the wiring structure is complicated, it is possible to calculate a highly precise wiring capacitance by referring to a wiring structure model similar to the wiring structure.

The wiring structure models for the capacitance mode information are shown in FIGS. 10A, 10B and 10C. In the step S19, the wiring capacitance of the target wiring conductor is calculated by use of a capacitance simulator by taking into consideration the variation in the fabricating process. The wiring capacitance thus calculated corresponds to capacitance information corresponding to the respective wiring structure model, and constitutes the capacitance model information, in combination with the wiring structure models.

In the above explanation, it has been described that the wiring structure models in consideration of the variation in the wiring and the corresponding capacitance model information are previously prepared. In this case, the wiring capacitance of the wiring conductor can be calculated highly precisely, but another problem is encountered in which a long processing time is required to generate the capacitance model information, and the data amount of the capacitance model information become very large.

In another method of the present invention, when the capacitance model information is generated in the step S19, only the capacitance model information for the central value of the conductor width of the target wiring conductor is generated. In other words, in FIGS. 10A, 10B, and 10C, the capacitance model information is constituted of the wiring structure models 101, 111, 114, 121, 124, . . . and the capacitance information corresponding to those wiring structure models.

In this case, when the wiring conductor width varies, the degree of calculation of the wiring capacitance becomes low to some extent, but it is advantageous that the capacitance model information can be quickly generated, and the data amount of the capacitance model information is small.

In the second method, the capacitance model information is generated in the step S19 from the process information, without needing the wiring variation information as shown in FIG. 3.

Returning to the processing flow of FIG. 3, the explanation will be continued. The wiring capacitance is calculated in the step S15 by using the information of the variational target wiring conductors, the variational side wiring conductors and the variational crossing wiring conductors generated in the step S12, the information of wiring segments generated in the step S13, and the capacitance mode information stored in the capacitance mode information storing means 31.

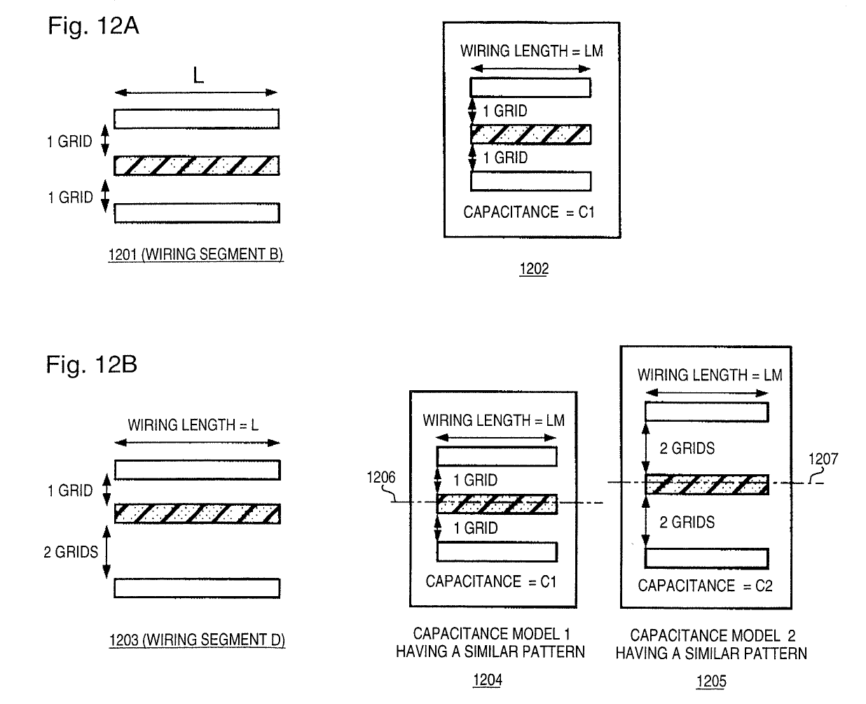

Next, the wiring capacitance calculating method will be specifically described mainly with reference to FIGS. 10A, 10B and 10C and FIGS. 12A and 12B.

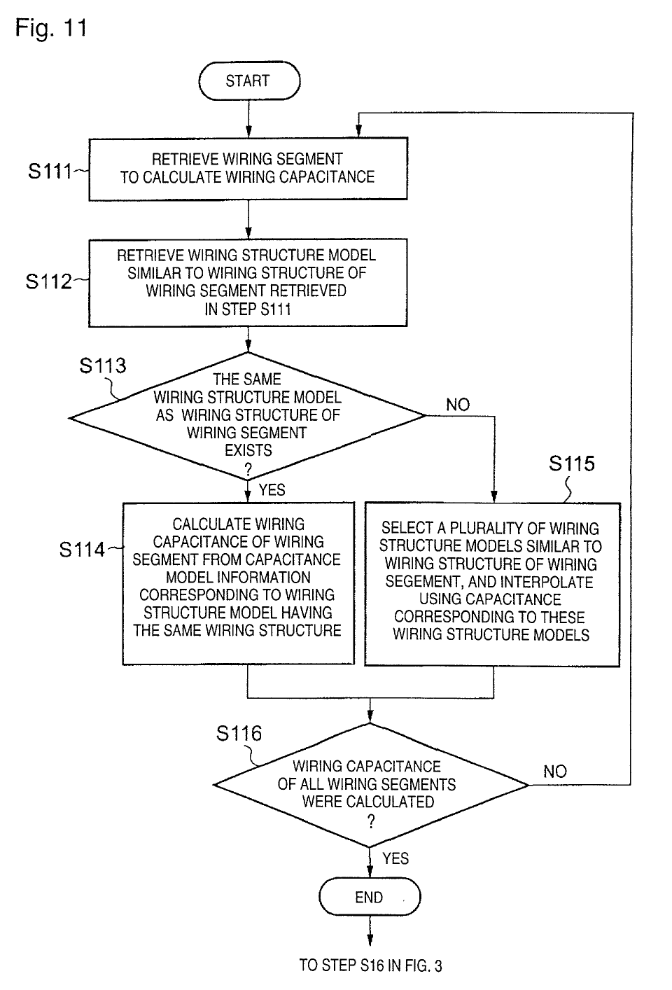

FIG. 11 is a flow chart illustrating the wiring resistance calculating method in the circuit simulation method and system in accordance with the present invention. In a step S111, a wiring segment necessary to calculate the wiring capacitance is retrieved.

In a next step S112, a wiring structure model similar to the wiring structure of the wiring segment selected in the step S111, and in a step S113, whether or not the capacitance mode information includes a wiring structure model having the same wiring structure as that of the wiring segment, is discriminated.

When it is discriminated in the step S113 that the capacitance mode information includes a wiring structure model having the same wiring structure as that of the wiring segment, the wiring capacitance of the wiring segment is calculated in a step S114 on the basis of the capacitance mode information of the wiring structure model having the same wiring structure.

When it is discriminated in the step S113 that the capacitance mode information does not include a wiring structure model having the same wiring structure as that of the wiring segment, a plurality of wiring structure models similar to the wiring structure of the wiring segment are selected in a step S115, and the wiring capacitance of the wiring segment is calculated by use of interpolation using the capacitance mode information corresponding to the selected wiring structure models.

In a next step S116, whether or not the wiring capacitance of all the wiring segements has been calculated, is discriminated. If it is discriminated that the wiring capacitance of all the wiring segements has been calculated, the processing for extracting the wiring capacitance is completed, and the wiring capacitance of all the wiring segments calculated in the step S114 and/or S115 is outputted. On the other hand, if it is discriminated that the wiring capacitance of all the wiring segements has not yet been calculated, namely, there remains a not-calculated wiring segment, the processing returns to the step S111, and the processing of the steps S111 to S116 is repeated until the wiring capacitance of all the wiring segements has been calculated.

Now, the above mentioned processing flow will be specifically described with references to FIGS. 7, 11 and 12. In a step S111, one of the target wiring conductors “A” to “I” shown in FIG. 7, for example, the target wiring conductor “B” is selected as the result of the retrieval.

In the next step S112, the wiring structure model similar to the wiring structure of the wiring segment “B” is retrieved in the capacitance model information. A wiring structure model 1202 in FIG. 12A is a wiring structure model most similar to the wiring segment “B”, namely, the wiring structure 1201. The wiring structure model 1202 is the same as that of the wiring structure 1201, excepting for the length of the target wiring conductor. Accordingly, the wiring capacitance C111 of the wiring segment “B”, namely, the wiring structure 1201 is calculated in accordance with the following equation in a step S114.

C111=C1×(L/LM) (1)

where

C1 is the wiring capacitance of the target wiring conductor in the wiring structure model 1202;

L is the wiring length of the wiring segment “B”; and

LM is the wiring length of the wiring structure model 1202.

Next, explanation will be made on the case in which the wiring segment “D” shown in FIG. 7 is selected as the result of the retrieval in the step S111 in FIG. 11. A wiring structure 1203 in FIG. 12B corresponds to the wiring segment “D”, and a wiring structure model similar to the wiring segment “D” is retrieved in the step S112.

As a result, if it is discriminated in the step S113 that there exists no capacitance model information of the wiring structure model having the same as that of the wiring segment “D”, namely, the wiring structure 1203, a plurality of wiring structure models similar to the wiring structure of the wiring segment are selected in the step S115. Wiring structure models 1204 and 1205 are the wiring structure models similar to the wiring structure of the wiring segment “D”.

Namely, the spacing between the wiring segment “D” and both the side wiring conductors is one grid and two grids. Namely, both the side wiring conductors are in asymmetry in connection with the target wiring conductor. In the case that there is no wiring structure model having side wiring conductors in asymmetry in connection with the target wiring conductor, the capacitance C113 of the wiring segment is calculated in accordance with the following equation by using the wiring structure models 1204 and 1205.

C113={(C1+C2)/2}×(L/LM) (2)

where C2 is the wiring capacitance of the target wiring conductor in the wiring structure model 1205.

Both the wiring structure models 1204 and 1205 have the side wiring conductors in symmetry in connection with the target wiring conductor. It can be deemed that a partial capacitance of the target wiring conductor is equal at opposite sides of a center axis 1206 and 1207 of the target wiring conductor. The contribution of both the side wiring conductors to the wiring segment “D” can be considered to be a parallel connection. Therefore, the capacitance C113 of the wiring segment is calculated in accordance with the following equation (2).

In the above, the method for calculating the wiring capacitance of the wiring segment, namely, the wiring capacitance between the nodes designated by the circuit connection information, has been explained by comparing and collating the wiring segment with the wiring structure models shown in FIGS. 10A, 10B and 10C, and using the same wiring structure or the similar wiring structures. In this case, the comparing and collating method includes two methods.

A first method is: The wiring structure models in consideration of the wiring conductor width variations are prepared as a portion of the capacitance model information as shown in FIGS. 10A, 10B and 10C, and the wiring structure models thus prepared are compared and collated with the wiring structure constituted of the variational target wiring conductors, the variational side wiring conductors and the variational crossing wiring conductors generated in the step S12. In this method, the variation in the wiring conductor width can be precisely reflected to the wiring capacitance, so that the wiring capacitance of the wiring conductor can be precisely calculated.

A second method is: Only the wiring structure models on the basis of only the central value of the wiring conductor width variations are prepared, and the wiring structure models thus prepared are compared and collated with the wiring structure constituted of the variational target wiring conductors, the variational side wiring conductors and the variational crossing wiring conductors. In this method, when the wiring conductor width varies, the calculation precision of the wiring capacitance lowers to some extent, but it is advantageous that the capacitance model information can be generated at a high speed, and the data amount of the capacitance model information becomes small.

In FIGS. 12A and 12B, it has been described that the hatched wiring conductor is the target wiring conductor. Furthermore, the effect of the crossing wiring conductor has been ignored in the above explanation in order to simplify the explanation, but now, the processing shown in FIG. 11 is inherently executed including the crossing wiring conductor.

Next, returning to the step S16 in FIG. 3, whether or not the wiring resistance and the wiring capacitance have been calculated in consideration of all the variation conditions of the wiring conductor width on the basis of the wiring conductor variation information stored in the wiring conductor variation information storing means 12, is discriminated. If the wiring resistance and the wiring capacitance have been calculated in consideration of all the variation conditions of the wiring conductor width, the processing goes into a step S17. If the wiring resistance and the wiring capacitance have not yet been calculated in consideration of all the variation conditions of the wiring conductor width, namely, if a not-calculated variation condition of the wiring conductor width remains, the operation returns to the step S12, and the processing to the step S15 is repeated until all the wiring resistance and the wiring capacitance have been calculated in consideration of all the variation conditions of the wiring conductor width. In the examples shown in FIGS. 8A, 8B and 8C, the processing of the steps S12 to S15 is executed by changing the wiring conductor width in the order of FIG. 8A to FIG. 8B to FIG. 8C.

In the step S17 of FIG. 3, whether or not the wiring resistance and the wiring capacitance have been calculated for all the target wiring conductors is discriminated. If the wiring resistance and the wiring capacitance have been calculated for all the target wiring conductors, the processing goes to a step S18. If the wiring resistance and the wiring capacitance have not yet been calculated for all the target wiring conductors, in other words, if a not-calculated target wiring conductor remains, the processing returns to the step S11, and the processing to the step S17 is repeated until the wiring resistance and the wiring capacitance have been calculated for all the target wiring conductors.

In the step S18, the circuit connection information including the wiring resistance and the wiring capacitance is generated on the basis of the wiring resistance and the wiring capacitance in consideration of the variation, calculated in the steps S14 and S15. This information thus generated is outputted to the circuit connection information storing means 15 for storing the circuit connection information including the wiring resistance and the wiring capacitance in consideration of the variation

As mentioned above, in the circuit simulation method and system in accordance with the present invention, the variation in the wiring capacitance caused by a mutual action between the target wiring conductor and the side wiring conductor and the crossing wiring conductor which exist in the circumference of the target wiring conductor, is not obtained by simply changing the arguments in the function. The circuit simulation method and system in accordance with the present invention can obtain the highly precise wiring capacitance in consideration of the variation in the fabrication process, by generating the wiring structure which includes the circumjacent wiring conductors existing in the circumference of the target wiring conductor and which is obtained in consideration of the variation condition, and by calculating the wiring capacitance on the basis of the wiring structure.

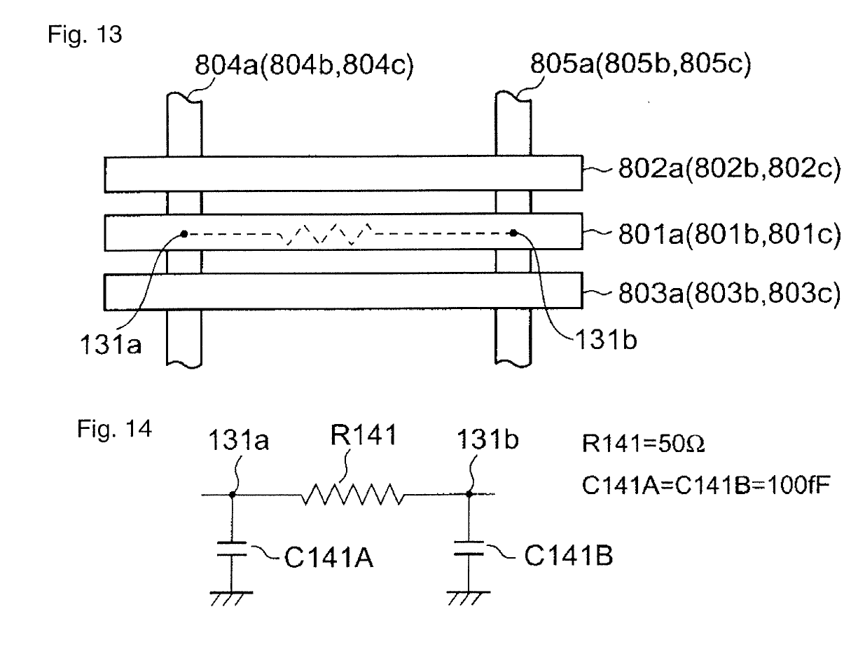

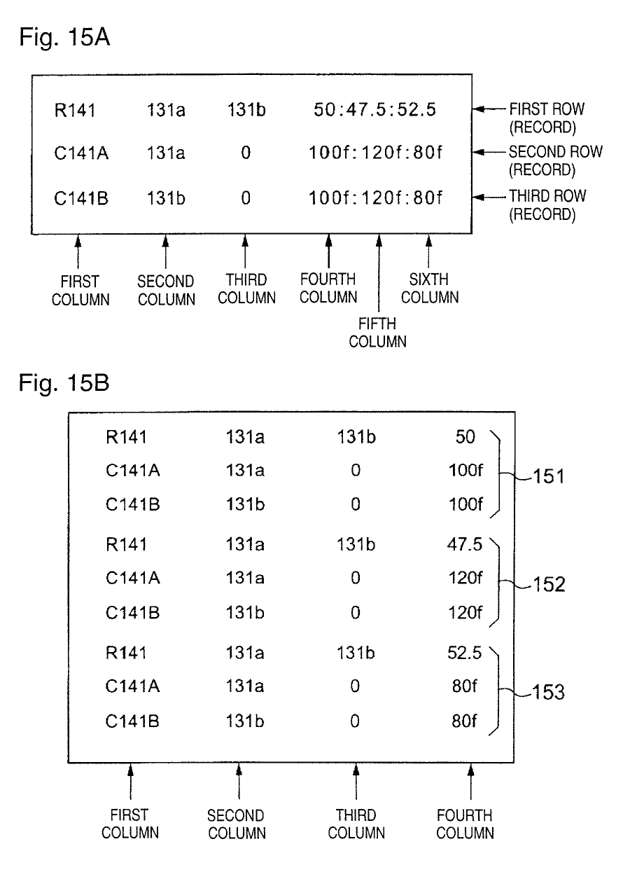

Now, the circuit connection information generated in the step S18 including the wiring resistance and the wiring capacitance in consideration of the variation, will be specifically described with FIG. 13, FIG. 14, FIGS. 15A and 15B.

FIG. 13 is the same as the wiring structures shown in FIGS. 8A, 8B and 8C. Nodes 131a and 131b are set at crossing points between target wiring conductors 801a to 801c and crossing wiring conductors 804a to 804c and 805a to 805c.

FIG. 14 is an equivalent circuit diagram including a wiring resistance R141 between nodes 131a and 131b and wiring capacitance C141A and C141B, prepared by using a “π”-type approximation. Here, a central resistance value 50Ω of the wiring resistance R141 is a value calculated by using the resistance calculating equation shown in FIG. 9A. The wiring capacitance C141A and C141B are a half of the capacitance value calculated by using the equation (1).

FIGS. 15A and 15B show the circuit connection information including the wiring resistance and the wiring capacitance in consideration of the variation, between the nodes 131a and 131b. In FIG. 15A, a first column indicates the name of circuit elements, and second and third columns show connection information. Fourth to sixth columns indicate device parameters of the circuit elements under the variation conditions. Here, the fourth column shows the device parameters in the case that the wiring conductor width assumes the central value. The fifth column shows the device parameters in the case that the wiring conductor width assumes the maximum value. The sixth column shows the device parameters in the case that the wiring conductor width assumes the minimum value.

Next, a first row (record) will be described. In this row (record), a left end R141 indicates a circuit element name R141. Since R indicates a resistor, it means that the resistor R141 is connected between the nodes 131a and the node 131b and assumes the resistance of 50Ω, 47.5Ω and 52.5Ω when the wiring conductor width assumes the central value, the maximum value and the minimum value, respectively.

A second row (record) will be described. In this row (record), a left end C141A indicates a circuit element name C141A. Since C indicates a capacitor, it means that the capacitor C141A is connected between the node 131a and ground (0) and assumes the capacitance of 100 fF, 120 fF and 80 fF when the wiring conductor width assumes the central value, the maximum value and the minimum value, respectively. A third row (record) is similar to the second row (record).

On the other hand, FIG. 15B shows the circuit connection information including the wiring resistance and the wiring capacitance in consideration of the variation, which is generated in accordance with a conventional method. First to third columns are similar to those in FIG. 15A. The reference numbers 151 to 153 show device parameters of the circuit elements under the variation conditions. Here, first row (record) to third row (record) indicate the device parameters in the case that the wiring conductor width assumes the central value (variation condition 151). Fourth row (record) to sixth row (record) show the device parameters in the case that the wiring conductor width assumes the maximum value (variation condition 152). Seventh row (record) to ninth row (record) show the device parameters in the case that the wiring conductor width assumes the minimum value (variation condition 153).

As seen from the above, the circuit connection information including the wiring resistance and the wiring capacitance in consideration of the variation, which is generated in accordance with a conventional method, needs the data amount which is about three times that required in the circuit connection information including the wiring resistance and the wiring capacitance in consideration of the variation, which is generated in accordance with the present invention.

As mentioned above, in the circuit simulation method and system in accordance with the present invention, the same record on one net list of the semiconductor integrated circuit includes information of the wiring resistance and the wiring capacitance in consideration of all the variation conditions. Therefore, it is not necessary to individually generate the net lists corresponding to all the variation conditions, with the result that the required data amount becomes small.

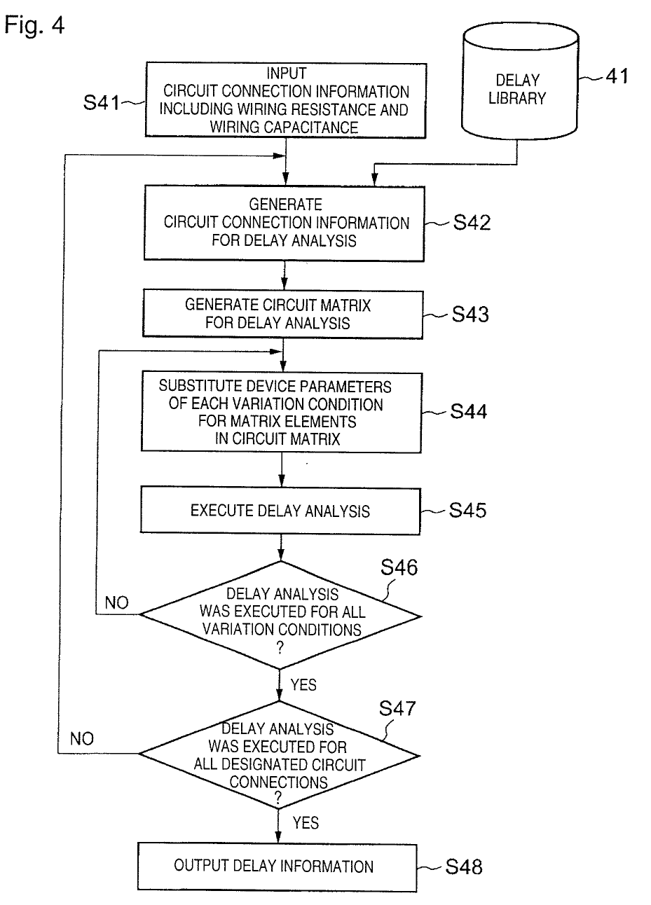

Next, an operation of the simulation means 16 taking the wiring variation into consideration, will be described with reference to FIG. 4.

FIG. 4 is a flow chart illustrating the operation of the simulation means 16 taking the wiring variation into consideration. In a first step S41, the circuit connection information including the wiring resistance and the wiring capacitance is inputted from the circuit connection information storing means 15 shown in FIG. 1 for storing the circuit connection information including the wiring resistance and the wiring capacitance in consideration of the variation

In a next step S42, a circuit connection information for a delay analysis is generated on the basis of the circuit connection information including the wiring resistance and the wiring capacitance inputted in the step S41, and delay library information stored in a delay library 41, including an output resistance of a driver cell and an input capacitance of a receiver cell.

Then, in a step S43, a circuit matrix for the delay analysis is generated by generating a node equation on the basis of the circuit connection information generated in the step S42. In a step S44, device parameters are substituted for respective matrix elements in the circuit matrix for each of the variation conditions.

In a succeeding step S45, the delay time is calculated by executing a delay analysis based on a transition analysis using the circuit matrix set for each of the variation conditions.

In a step S46, whether or not the delay analysis has been executed for all the variation conditions, is discriminated. If it is discriminated that the delay analysis has been executed for all the variation conditions, the processing goes into a next step S47. If it is discriminated that the delay analysis has not yet been executed for all the variation conditions, namely there remains a variation condition for which the delay analysis has been executed, the processing returns to the step S44. The processing of the steps S44 and S45 is repeated until the delay analysis has been executed for all the variation conditions.

In the step S47, whether or not the delay analysis has been executed for all the designated circuit connections, is discriminated. If it is discriminated that the delay analysis has been executed for all the designated circuit connections, the processing goes into a next step S48. If it is discriminated that the delay analysis has not yet been executed for all the designated circuit connections, namely, there remains a not-analyzed circuit connection remains in the designated circuit connections, the processing returns to the step S42. The processing of the steps S42 and S46 is repeated until the delay analysis has been executed for all the designated circuit connections.

In the step S48, the delay information generated in the step S45 for all the designated circuit connections based on all the variation conditions is outputted to the simulation result storing means 17 shown in FIG. 1.

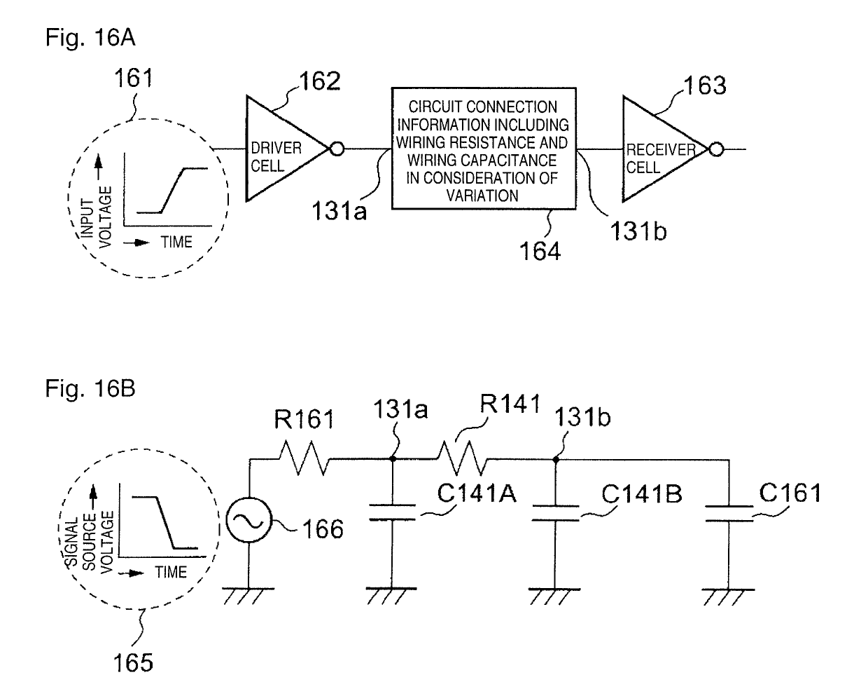

The processing flow shown in FIG. 4 will be specifically described with reference to FIG. 16A to FIG. 18.

FIG. 16A is an example of circuit connection information including the wiring resistance and the wiring capacitance, inputted in the step S41 in FIG. 4. Reference number 161 designates a waveform of an input voltage applied to a driver cell 162. Reference number 163 denotes a receiver cell. The reference number 164 shows a circuit connection information which is connected between an output terminal of the driver cell 162 and an input terminal of the receiver cell 163 and which includes the wiring resistance and the wiring capacitance in consideration of the variation. Here, an example having the wiring structure shown in FIGS. 8A, 8B and 8C and FIG. 13 as the circuit connection information will be described.

FIG. 16B is a circuit connection information for delay analysis, which is generated by using the circuit connection information shown in FIG. 16A and an output resistance R161 of the driver cell 162 and an input capacitance C161 of the receiver cell 163, which are stored in the delay library41.

Here, the reference number 165 shows a signal waveform of a signal source 166 obtained by replacing the driver cell 162 by a signal source 166 and the output resistance R161. The nodes 131a and 131b, the wiring resistance 141, the wiring capacitance C141A and C141B correspond to those shown in FIG. 14 extracted from the wiring structure shown in FIGS. 8A, 8B and 8C and FIG. 13, respectively.

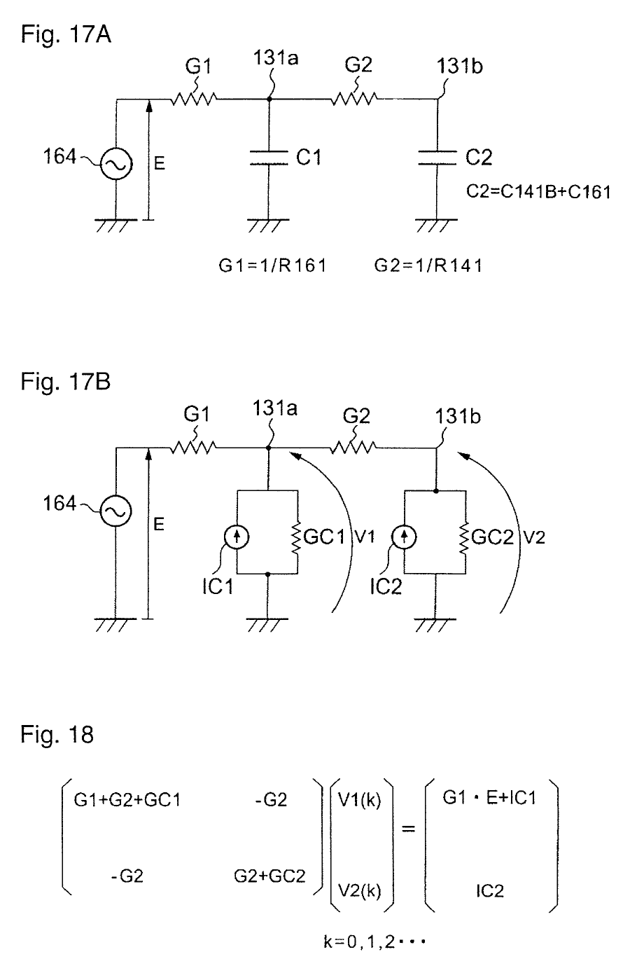

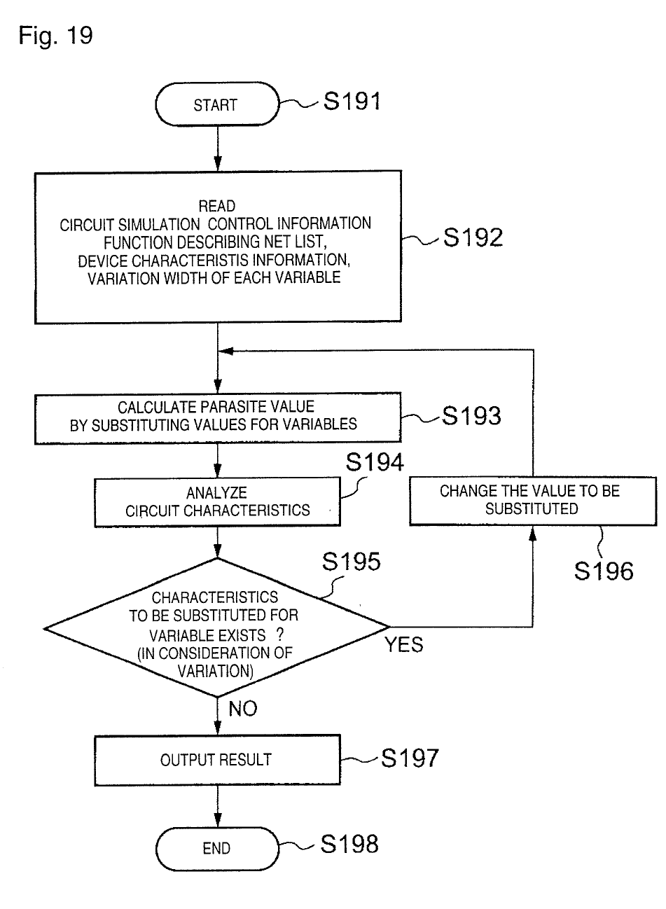

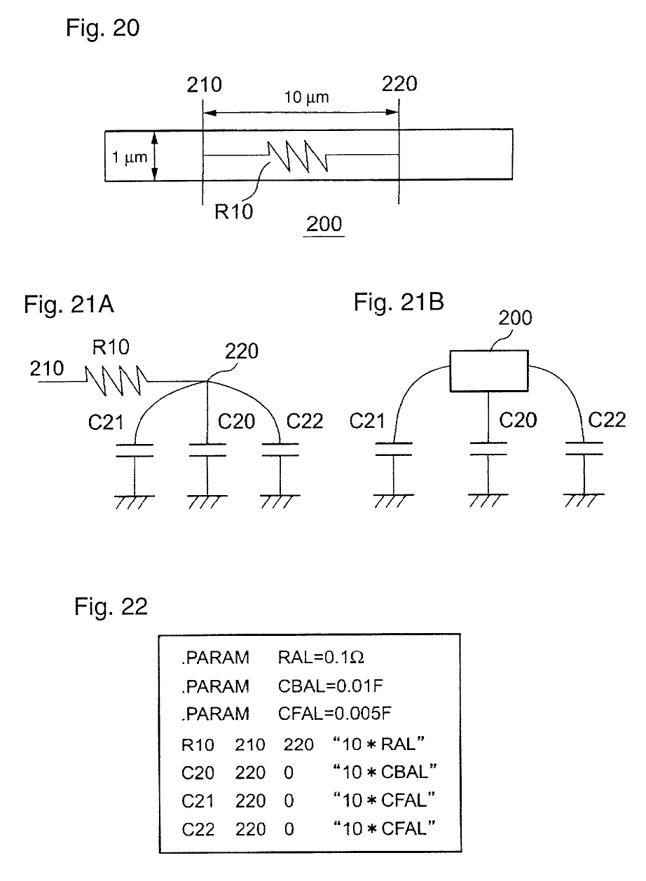

FIG. 17A is an equivalent circuit diagram, using conductance, corresponding to the circuit connection information for delay analysis shown in FIG. 16A. The conductance G1 and G2 are calculated as G1=1/R161 and G2=1/R141, and a synthesized capacitance C2 is calculated as C2=C141B+C161.

FIG. 17B is a circuit diagram prepared by replacing the capacitance C1 and C2 in the equivalent circuit diagram shown in FIG. 17A, by constant current sources IC1 and IC2 through which constant currents IC1 and IC2 flow respectively, and conductance GC1 and GC2.

FIG. 18 is a circuit matrix for delay analysis, generated in the step S43, prepared on the basis of the circuit diagram shown in FIG. 17B. V1(k) and V2(k) indicate voltages at the nodes 131a and 131b at a time step “k”. The delay analysis in the step S45 is carried out by substituting the wiring resistance and the wiring capacitance for each of the variation conditions shown in FIG. 15A, for respective matrix elements in the circuit matrix shown in FIG. 18. Namely, the voltages V1(k) and V2(k) are calculated by gradually increasing the time step “k” in the circuit matrix shown in FIG. 18 from an initial condition of t=0 (k=0).

Thus, in the step S46, the voltages V1(k) and V2(k) are calculated as mentioned above for all the variation conditions of the fourth to sixth columns in FIG. 15A.

In the above mentioned description, the variation in the wiring conductor width has been mainly considered as the variation conditions in the fabricating process. However, it is possible to generate the wiring structure models in the step S19 of FIG. 3, by taking into consideration not only the variation in the wiring conductor width but also variation in the film thickness of the wiring conductor layer, variation in the film thickness of an interlayer insulating film and variation in the dielectric constant of the interlayer insulating film, and then, to calculate the wiring capacitance for each of the variation conditions in the step S15 in FIG. 3. In this case, it is possible to calculate the wiring resistance and the wiring capacitance which further precisely reflect the variation in the fabricating process.

In addition, in the above mentioned description, three parameters in connection with the variation range in the fabricating process, including the central value of the variation, the maximum value of the variation and the minimum value of the variation have been exemplified. However, in place of these variation range factors, it is possible to use values which can be obtained by multiplying a standard deviation of the variation range by integer.

In this case, if the fabricating process have many variation factors, if the calculation is simply carried out on the basis of the worst case, the delay value obtained in the step S45 of FIG. 4 becomes very large. Therefore, assuming that the standard deviation is σ, if the delay analysis is carried out by restricting the variation range to 3σ, it is possible to obtain a delay information near to the actual variation in the fabrication process.

As mentioned above, the circuit simulation method and system in accordance with the present invention applied to a semiconductor integrated circuit has been described. However, the circuit simulation method and system in accordance with the present invention can be applied to a circuit other than the semiconductor integrated circuit, for example, a circuit constituted of circuit elements mounted on the same circuit board, such as a circuit constituted of integrated circuits mounted on a printed circuit.

As mentioned above, in the circuit simulation method and system in accordance with the present invention, the variation in the wiring capacitance of the target wiring conductor obtained by considering the target wiring conductor and the side wiring conductor and the crossing wiring conductor which exist in the circumference of the target wiring conductor, is not obtained by simply changing the arguments in the function. The circuit simulation method and system in accordance with the present invention can obtain the highly precise wiring capacitance in consideration of the variation in the fabrication process, by generating the wiring structure which includes the circumjacent wiring conductors existing in the circumference of the target wiring conductor and which is obtained in consideration of the variation condition, and by calculating the wiring capacitance on the basis of the wiring structure thus obtained.

Furthermore, in the circuit simulation method and system in accordance with the present invention, since one net list of the semiconductor integrated circuit includes information of the wiring resistance and the wiring capacitance in consideration of all the variation conditions, it is not necessary to individually generate the net lists corresponding to all the variation conditions, with the result that the required data amount becomes small.

In addition, in the circuit simulation method and system in accordance with the present invention, the wiring structure is not generated by a designer manually taking a variation condition into consideration, but the variational target wiring conductors, the variational side wiring conductors and the variational crossing wiring conductors are automatically generated by referring to the wiring variation information stored in the wiring variation information storing means, so that a designer's load is small and no mistake occurs.

Furthermore, differently from a method in which the wiring resistance and the wiring capacitance of the target wiring conductor are calculated after the wiring structures of all wiring conductors formed on a semiconductor chip are generated in the number of variation conditions and the layout data corresponding to all the variation conditions is inputted, the circuit simulation method and system in accordance with the present invention can calculate the wiring resistance and the wiring capacitance at a high speed, since only the wiring structure, based on the variation conditions, composed of the target wiring conductor and the circumjacent wiring conductors giving influence to the capacitance of the target wiring conductor, is generated and then the wiring resistance and the wiring capacitance are calculated. As a result, the whole of the delay analysis can be executed at an elevated processing speed.

1. A circuit simulation method for executing a delay analysis of a wiring conductor in consideration of size variations in a fabrication process from a designed value, comprising:
the step of retrieving, from a layout information, a target wiring structure including a target wiring conductor for which the delay analysis is to be executed and a target adjacent wiring conductor adjacent to said target wiring conductor;
the step of calculating a wiring resistance for each of variations in at least a wiring conductor width of said target wiring conductor;
from a capacitance model information previously including, for reference wiring structures composed of a reference wiring conductor of a unitary length and a reference adjacent wiring conductor adjacent to said reference wiring conductor in a positional relation, a wiring capacitance of said reference wiring conductor for each of said reference wiring structures corresponding to at least a plurality of wiring conductor widths, the step of selecting said reference wiring structure similar to said target wiring structure, and calculating, on the basis of the wiring capacitance of said reference wiring conductor of said reference wiring structure thus selected, the wiring capacitance of said target wiring conductor for each of variations in at least a wiring conductor width of said target wiring conductor and said target adjacent wiring conductor; and
the step of executing a delay analysis of said target wiring conductor by using the wiring resistance and the wiring capacitance of said target wiring conductor for each of variations in the size of said target wiring conductor.

2. A circuit simulation method claimed in claim 1 wherein said target adjacent wiring conductor is within a predetermined distance from said target wiring conductor.

3. A circuit simulation method claimed in claim 1, further including:
the step of segmentalizing said target wiring conductor at at least one of a wiring conductor width changing point of said target wiring conductor, a changing point of a spacing between said target wiring conductor and said target adjacent wiring conductor, and a crossing point where said target wiring conductor crosses another wiring conductor, and wherein said step for calculating the wiring capacitance of said target wiring conductor calculates the wiring capacitance for each of wiring conductor segments obtained by said segmentalizing.

4. A circuit simulation method comprising:
a wiring conductor retrieving step of retrieving, on the basis of a layout information of an integrated circuit, a designated target wiring conductor included in said layout information, a side wiring conductor adjacent to said target wiring conductor and positioned at the same wiring conductor level as that of said target wiring conductor, and a crossing wiring conductor spatially crossing said target wiring conductor;
a variational wiring conductor generating step of generating variational target wiring conductors, variational side wiring conductors and variational crossing wiring conductors in consideration of variation in said target wiring conductor, said side wiring conductor and said crossing wiring conductor, on the basis of connection information of said target wiring conductor, said side wiring conductor and said crossing wiring conductor and a wiring conductor variation information which is variation information of wiring conductors, so as to generate variational wiring structures constituted of said variational target wiring conductors, said variational side wiring conductors and said variational crossing wiring conductors;
a wiring conductor segmentalizing step of segmentalizing said variational target wiring conductor into wiring segments on the basis of a wiring structure constituted of wiring conductors including said target wiring conductor, said side wiring conductor and said crossing wiring conductor;
a wiring resistance calculating step of calculating a wiring resistance of said wiring segments on the basis of process information and information of said wiring segments;
a wiring capacitance calculating step of calculating a wiring capacitance of said wiring segments included in said variational wiring structures, for each of variation conditions, by referring to information of a wiring structure model which is a fundamental wiring structure constituted of wiring conductors including said target wiring conductor, said side wiring conductor and said crossing wiring conductor, to capacitance model information including information of wiring capacitance of the target wiring conductor included in said wiring structure model, calculated on the basis of information of said wiring structure model and said process information, and to said variational wiring structures;
a circuit connection information generating step for generating circuit connection information including information of said wiring resistance and said wiring capacitance, on the basis of said wiring resistance and said wiring capacitance calculated in said wiring resistance calculating step and said wiring capacitance calculating step, respectively; and
a variation considering delay analysis step of executing a delay analysis of said integrated circuit in consideration of variation in said wiring resistance and said wiring capacitance included in said circuit connection information, on the basis of said circuit connection information including information of said wiring resistance and said wiring capacitance, generated in said circuit connection information generating step.

5. A circuit simulation method claimed in claim 4 wherein said delay analysis step includes:
a circuit connection information generating step for generating circuit connection information for the delay analysis, obtained by converting a circuit block included in the circuit connection information including said wiring resistance and said wiring capacitance, into basic circuit elements;
a circuit matrix generating step for generating a circuit matrix for the delay analysis, on the basis of said circuit connection information for the delay analysis;
a variation condition setting step for setting said wiring resistance and said wiring capacitance for each of the variation conditions, into matrix elements in said circuit matrix for the delay analysis; and
a delay value calculating step of calculating the delay value for each of the variation conditions, by using said circuit matrix for the delay analysis set in said variation condition setting step.

6. A circuit simulation method claimed in claim 4 wherein said wiring conductor segmentalizing step includes:
an initial value setting step for setting initial values including a retrieval area width which is a threshold of a distance from said target wiring conductor;
a side wiring conductor discriminating step for discriminating whether or not a wiring conductor of the same wiring conductor layer as that of said target wiring conductor exists within said retrieval area width;
a plural wiring conductor discriminating step for discriminating, when it is discriminated in said side wiring conductor discriminating step that a wiring conductor of the same wiring conductor layer as that of said target wiring conductor exists within said retrieval area width, whether or not a plurality of wiring conductors exist within said retrieval area width;
a side wiring conductor extracting step for extracting, when it is discriminated in said plural wiring conductor discriminating step that a plurality of wiring conductors exist within said retrieval area width, a wiring conductor nearest to the target wiring conductor, of the plurality of wiring conductors, as a side wiring conductor, and alternatively, when it is discriminated in said plural wiring conductor discriminating step that a plurality of wiring conductors do not exist within said retrieval area width, the wiring conductor existing within said retrieval area width, as said side wiring conductor.

7. A circuit simulation method claimed in claim 4 wherein said wiring conductor segmentalizing step includes:
a side wiring conductor extracting step for extracting said side wiring conductor;
a wiring spacing changing point extracting step for extracting a wiring spacing changing point where a spacing between said target wiring conductor and said side wiring conductor changes;
a wiring conductor width changing point extracting step for extracting a wiring conductor width changing point where the conductor width of said target wiring conductor changes;
a crossing point extracting step for extracting a crossing point where said target wiring conductor crosses said crossing wiring conductor;
a bending point extracting step for extracting a bending point where said target wiring conductor bends, and
a segmentalizing step of setting nodes on said wiring spacing changing point, said wiring conductor width changing point, said bending point and said crossing point and segmentalizing said target wiring conductor into said wiring segments by said nodes thus set.

8. A circuit simulation method claimed in claim 4 wherein said variational wiring conductor generating step includes:
a processing for increasing respective conductor widths of said target wiring conductor, said side wiring conductor and said crossing wiring conductor by a first variation width, and
a processing for decreasing said respective conductor widths of said target wiring conductor, said side wiring conductor and said crossing wiring conductor by a second variation width.

9. A circuit simulation method claimed in claim 4 wherein said wiring structure model includes:
an isolated wiring structure constituted of an isolated wiring conductor having a constant length;
a side wiring structure constituted of said target wiring conductor having a constant length and said side wiring conductor which is located at one side or each side of said target wiring conductor and which is separated from said target wiring conductor by a distance which is integer number times of a predetermined spacing; and
a cross wiring structure constituted of said target wiring conductor having a constant length, said side wiring conductor which is located at one side or each side of said target wiring conductor and which is separated from said target wiring conductor by a distance which is integer number times of a predetermined spacing, and said crossing wiring conductor crossing said target wiring conductor.

10. A circuit simulation method claimed in claim 4 wherein said wiring capacitance calculating step includes:
a wiring segment retrieving step for retrieving said wiring segment for calculation of a wiring capacitance;
a wiring structure retrieving step for retrieving a wiring structure model or a variational wiring structure model nearest to a segmentary wiring structure constituted of said wiring segment selected in said wiring segment retrieving step as well as said side wiring conductor and said crossing wiring conductor for said wiring segment selected, a capacitance model information storing means storing a plurality of wiring structure models and a plurality of variational wiring structure models;
a wiring structure model discriminating step for discriminating whether or not the wiring structure model selected in said wiring structure retrieving step is the same as said segmentary wiring structure;
a first wiring segment capacitance calculating step, when it is discriminated in said wiring structure model discriminating step that the wiring structure model or the variational wiring structure model selected in said wiring structure retrieving step is the same as said segmentary wiring structure, for calculating the wiring capacitance of said wiring segment by referring to the wiring capacitance of the target wiring segment in the wiring structure model or the variational wiring structure model;
a second wiring segment capacitance calculating step, when it is discriminated in said wiring structure model discriminating step that the wiring structure model or the variational wiring structure model selected in said wiring structure retrieving step is not the same as said segmentary wiring structure, for selecting a plurality of wiring structure models or variational wiring structure models similar to said segmentary wiring structure, and for calculating the wiring capacitance of said wiring segment by interpolation of a plurality of wiring capacitance in the plurality of wiring structure models or variational wiring structure models thus selected; and
a wiring segment completion discriminating step for discriminating whether or not the wiring capacitance of all said wiring segments has been calculated, and outputting the wiring capacitance of all said wiring segments calculated in said first and second wiring segment capacitance calculating step when it is discriminated that the wiring capacitance of all said wiring segments has been calculated, or alternatively returning to said wiring segment retrieving step when it is discriminated that the wiring capacitance of all said wiring segments has not yet been calculated.

11. A circuit simulation method claimed in claim 4 wherein a circuit element name and variation value of its circuit element characteristics, including a wiring resistance and a wiring capacitance, of said circuit connection information including information of said wiring resistance and information of said wiring capacitance, generated in said circuit connection information generating step, is stored in the same record.

12. A circuit simulation method comprising:
a wiring conductor retrieving step of retrieving, on the basis of a layout information of an integrated circuit, a designated target wiring conductor included in said layout information, a side wiring conductor adjacent to said target wiring conductor and positioned at the same wiring conductor level as that of said target wiring conductor, and a crossing wiring conductor spatially crossing said target wiring conductor;
a variational wiring conductor generating step of generating variational target wiring conductors, variational side wiring conductors and variational crossing wiring conductors in consideration of variation in said target wiring conductor, said side wiring conductor and said crossing wiring conductor, on the basis of connection information of said target wiring conductor, said side wiring conductor and said crossing wiring conductor and a wiring conductor variation information which is variation information of wiring conductors, so as to generate variational wiring structures constituted of said variational target wiring conductors, said variational side wiring conductors and said variational crossing wiring conductors;
a wiring conductor segmentalizing step of segmentalizing said variational target wiring conductor into wiring segments on the basis of a wiring structure constituted of said target wiring conductor, said side wiring conductor and said crossing wiring conductor;
a wiring resistance calculating step of calculating a wiring resistance of said wiring segments on the basis of process information and information of said wiring segments;
a wiring capacitance calculating step of calculating a wiring capacitance of said wiring segments included in said variational wiring structures, for each of variation conditions, by referring to information of a variational wiring structure model which is a fundamental wiring structure constituted of wiring conductors including said variational target wiring conductor, said variational side wiring conductor and said variational crossing wiring conductor, to capacitance model information including information of wiring capacitance of the variational target wiring conductor included in said variational wiring structure model, calculated on the basis of information of said variational wiring structure model and said process information, and to said variational wiring structures;
a circuit connection information generating step for generating circuit connection information including information of said wiring resistance and said wiring capacitance, on the basis of said wiring resistance and said wiring capacitance calculated in said wiring resistance calculating step and said wiring capacitance calculating step, respectively; and
a variation considering delay analysis step of executing a delay analysis of said integrated circuit in consideration of variation in said wiring resistance and said wiring capacitance included in said circuit connection information, on the basis of said circuit connection information including information of said wiring resistance and said wiring capacitance, generated in said circuit connection information generating step.

13. A circuit simulation method claimed in claim 12 wherein said delay analysis step includes:
a circuit connection information generating step for generating circuit connection information for the delay analysis, obtained by converting a circuit block included in the circuit connection information including said wiring resistance and said wiring capacitance, into basic circuit elements;
a circuit matrix generating step for generating a circuit matrix for the delay analysis, on the basis of said circuit connection information for the delay analysis;
a variation condition setting step for setting said wiring resistance and said wiring capacitance for each of the variation conditions, into matrix elements in said circuit matrix for the delay analysis; and
a delay value calculating step of calculating the delay value for each of the variation conditions, by using said circuit matrix for the delay analysis set in said variation condition setting step.

14. A circuit simulation method claimed in claim 12 wherein said wiring conductor segmentalizing step includes:
an initial value setting step for setting initial values including a retrieval area width which is a threshold of a distance from said target wiring conductor;
a side wiring conductor discriminating step for discriminating whether or not a wiring conductor of the same wiring conductor layer as that of said target wiring conductor exists within said retrieval area width;
a plural wiring conductor discriminating step for discriminating, when it is discriminated in said side wiring conductor discriminating step that a wiring conductor of the same wiring conductor layer as that of said target wiring conductor exists within said retrieval area width, whether or not a plurality of wiring conductors exist within said retrieval area width;
a side wiring conductor extracting step for extracting, when it is discriminated in said plural wiring conductor discriminating step that a plurality of wiring conductors exist within said retrieval area width, a wiring conductor nearest to the target wiring conductor, of the plurality of wiring conductors, as a side wiring conductor, and alternatively, when it is discriminated in said plural wiring conductor discriminating step that a plurality of wiring conductors do not exist within said retrieval area width, the wiring conductor existing within said retrieval area width, as said side wiring conductor.

15. A circuit simulation method claimed in claim 12 wherein said wiring conductor segmentalizing step includes:
a side wiring conductor extracting step for extracting said side wiring conductor;
a wiring spacing changing point extracting step for extracting a wiring spacing changing point where a spacing between said target wiring conductor and said side wiring conductor changes;
a wiring conductor width changing point extracting step for extracting a wiring conductor width changing point where the conductor width of said target wiring conductor changes;
a crossing point extracting step for extracting a crossing point where said target wiring conductor crosses said crossing wiring conductor;
a bending point extracting step for extracting a bending point where said target wiring conductor bends, and
a segmentalizing step of setting nodes on said wiring spacing changing point, said wiring conductor width changing point, said bending point and said crossing point and segmentalizing said target wiring conductor into said wiring segments by said nodes thus set.

16. A circuit simulation method claimed in claim 12 wherein said variational wiring conductor generating step includes:
a processing for increasing respective conductor widths of said target wiring conductor, said side wiring conductor and said crossing wiring conductor by a first variation width, and
a processing for decreasing said respective conductor widths of said target wiring conductor, said side wiring conductor and said crossing wiring conductor by a second variation width.

17. A circuit simulation method claimed in claim 12 wherein said wiring structure model includes:
an isolated wiring structure constituted of an isolated wiring conductor having a constant length;
a side wiring structure constituted of said target wiring conductor having a constant length and said side wiring conductor which is located at one side or each side of said target wiring conductor and which is separated from said target wiring conductor by a distance which is integer number times of a predetermined spacing; and
a cross wiring structure constituted of said target wiring conductor having a constant length, said side wiring conductor which is located at one side or each side of said target wiring conductor and which is separated from said target wiring conductor by a distance which is integer number times of a predetermined spacing, and said crossing wiring conductor crossing said target wiring conductor.

18. A circuit simulation method claimed in claim 12 wherein said wiring capacitance calculating step includes:
a wiring segment retrieving step for retrieving said wiring segment for calculation of a wiring capacitance;
a wiring structure retrieving step for retrieving a wiring structure model or a variational wiring structure model nearest to a segmentary wiring structure constituted of said wiring segment selected in said wiring segment retrieving step as well as said side wiring conductor and said crossing wiring conductor for said wiring segment selected, a capacitance model information storing means storing a plurality of wiring structure models and a plurality of variational wiring structure models;
a wiring structure model discriminating step for discriminating whether or not the wiring structure model selected in said wiring structure retrieving step is the same as said segmentary wiring structure;
a first wiring segment capacitance calculating step, when it is discriminated in said wiring structure model discriminating step that the wiring structure model or the variational wiring structure model selected in said wiring structure retrieving step is the same as said segmentary wiring structure, for calculating the wiring capacitance of said wiring segment by referring to the wiring capacitance of the target wiring segment in the wiring structure model or the variational wiring structure model;
a second wiring segment capacitance calculating step, when it is discriminated in said wiring structure model discriminating step that the wiring structure model or the variational wiring structure model selected in said wiring structure retrieving step is not the same as said segmentary wiring structure, for selecting a plurality of wiring structure models or variational wiring structure models similar to said segmentary wiring structure, and for calculating the wiring capacitance of said wiring segment by interpolation of a plurality of wiring capacitance in the plurality of wiring structure models or variational wiring structure models thus selected; and
a wiring segment completion discriminating step for discriminating whether or not the wiring capacitance of all said wiring segments has been calculated, and outputting the wiring capacitance of all said wiring segments calculated in said first and second wiring segment capacitance calculating step when it is discriminated that the wiring capacitance of all said wiring segments has been calculated, or alternatively returning to said wiring segment retrieving step when it is discriminated that the wiring capacitance of all said wiring segments has not yet been calculated.

19. A circuit simulation method claimed in claim 12 wherein a circuit element name and variation value of its circuit element characteristics, including a wiring resistance and a wiring capacitance, of said circuit connection information including information of said wiring resistance and information of said wiring capacitance, generated in said circuit connection information generating step, is stored in the same record.

20. A circuit simulation system comprising:
a layout information storing means for storing layout information of an integrated circuit;
a wiring variation information storing means for storing information of variations in wiring conductors;
a process information storing means for storing process information in a fabricating process for said integrated circuit;
a means for extracting wiring resistance and wiring capacitance obtained in consideration of variation, by extracting wiring resistance and wiring capacitance obtained in consideration of variation, on the basis of said layout information, said wiring variation information and said process information, so as to generate circuit connection information including information of wiring resistance and wiring capacitance derived by modifying the circuit connection information of said integrated circuit in view of the wiring resistance and the wiring capacitance thus obtained, and
a simulation means receiving the circuit connection information including said wiring resistance and said wiring capacitance, for executing a delay simulation of said integrated circuit in consideration of variation in said wiring conductors.
